(19) United States
(12) Patent Application Publication
(10) Pub. No.: US 2005/0105840 A1
(43) Pub. Date: May 19, 2005

(54) Bearing apparatus for a wheel of vehicle

(76) Inventors: Masahiro Muranaka, Iwata-shi (JP); Koji Nishino, Iwata-shi (JP)

Correspondence Address: HARNESS, DICKEY & PIERCE, P.L.C., P.O. BOX 828, BLOOMFIELD HILLS, MI, 48303, US

(21) Appl. No.: 10/963,355

(22) Filed: Oct. 12, 2004

(30) Foreign Application Priority Data
Oct. 16, 2003 (JP) 2003-356325

(51) Int. Cl. F16C 13/00; F16C 43/00

(52) U.S. Cl. 384/544

(57) ABSTRACT

A vehicle wheel bearing apparatus is simple to assemble and disassemble which reduces the man-hour in manufacturing and its manufacturing cost. The bearing apparatus has an inner member (1) including a wheel hub (2) integrally formed with a wheel mounting flange (5) at one end. Axially extending cylindrical portions (2a) and (2b) axially extend from the wheel mounting flange (5). Inner rings (3) and (4) are fitted on the axially extending cylindrical portions (2a) and (2b). An outer member (10) is fitted in a knuckle N which forms a part of a suspension apparatus. Double row rolling elements (6) and (6) are arranged between the inner and outer members (1) and (10). The wheel hub wheel, (2) is rotatably supported by the knuckle N. Annular stop ring grooves (11) and (12) are formed, respectively, on the outer circumferential surface of the outer member (10) and the inner circumferential surface of the knuckle N. A stop ring (13), with a predetermined shearing strength of 20˜200 MPa, is fitted in the stop ring grooves (11) and (12).

### CROSS-REFERENCE TO RELATED APPLICATIONS

This application claims priority to Japanese Patent Application No. 2003-356325, filed Oct. 16, 2003, which application is herein expressly incorporated by reference.

### FIELD OF THE INVENTION

The present invention relates to a bearing apparatus for a vehicle wheel that rotatably supports the wheel relative to a suspension apparatus of the vehicle and, more particularly, to an improvement of a mounting structure of the bearing apparatus for the vehicle wheel.

### BACKGROUND OF THE INVENTION

Various types of vehicle wheel bearing apparatus have been used in which outer and inner rings are rotatably combined with each other vial rolling elements therebetween to rotatably support the wheel of the vehicle relative to the suspension apparatus. Also known is a vehicle wheel bearing apparatus as shown in FIG. 4. Here, an outer ring forms the bearing for a wheel that is mounted to a knuckle forming an independent suspension.

The vehicle wheel bearing apparatus in FIG. 4 comprises an outer ring 101 fitted in a knuckle 104, a pair of inner rings 102 press-fitted on a hub wheel (not shown), and double row rolling elements 103 held in a cage 105 between the outer and inner rings 101 and 102. In order to eliminate an axial gap between the outer ring 101 and the knuckle 104 and to immovably secure the outer ring 101 relative to the knuckle 104, a stop ring 106, having a plurality of claws 107, is fitted in a space between the outer ring 101 and the knuckle 104. The claws 107 are elastically deformed radially inward. When the claws 107 arrive at a stop ring tapered groove 108 formed in the knuckle 104, the claws 107 spring back into the groove 108 and the tips of the claws 107. abut on a surface of the groove 108 (e.g., U.S. Pat. No. 5,927,867).

However, in the prior art bearing apparatus, it is difficult to disassemble the bearing from the knuckle 104 to service the vehicle. Thus, disassembly can never be achieved without destruction of the stop ring 106 which requires applying excess heavy load on the bearing. Accordingly, the knuckle 104 and the outer ring 101 are damaged after the disassembly. Thus, it is impossible to reuse not only the knuckle 104 but the whole bearing.

### SUMMARY OF THE INVENTION

It is, therefore, an object of the present invention to provide a bearing apparatus for a vehicle wheel which is simple to assemble and disassemble. Thus, the bearing apparatus can reduce the man-hour in manufacturing and its manufacturing cost.

According to the present invention, a vehicle wheel bearing apparatus comprises an inner member which includes a wheel hub integrally formed with a wheel mounting flange at one end. Axially extending- cylindrical portions axially extend from the wheel mounting flange. Also, inner rings are fitted on the axially extending cylindrical portions. An outer member is fitted in a knuckle which forms a part of a suspension apparatus. Double row rolling elements are arranged between the inner and outer members. The wheel hub is rotatably supported by the knuckle. Annular stop ring grooves are formed, respectively, on the outer circumferential surface of the outer member and the inner circumferential surface of the knuckle. A stop ring, with a predetermined shearing strength smaller than that of steel, is fitted in the stop ring grooves.

The fact that the annular stop ring grooves are formed respectively on the outer circumferential surface of the outer member and the inner circumferential surface of the knuckle, and that the stop ring has a predetermined shearing strength smaller than that of steel and is fitted in the stop ring grooves, enables easy destruct only of the stop ring. Thus to achieve disassembly, an axial load exceeding the breaking strength of the stop ring determined by its shearing strength is applied on the outer member. Accordingly, it is possible to reuse the knuckle and the outer member without causing damage to them. Thus, it is possible to provide a vehicle wheel bearing apparatus which is simple to assemble and disassemble and can reduce the man-hour in manufacturing and its manufacturing cost.

According to the invention, the shearing strength of the stop ring is set within a range of 20˜200 MPa. This prevents axial movement of the bearing relative to the knuckle in the normal use of the vehicle as well as to destroy the stop ring without applying an excessive heavy load to disassemble the bearing during service of the vehicle.

According to the invention, the stop ring is formed of thermoplastic resin. Thus, it is possible to obtain a desired shearing strength of the stop ring by appropriately selecting its material and reinforcing material and to reduce the manufacturing cost of the stop ring.

Preferably, the stop ring is formed with chamfers at the corners of the outer circumferential surface. This enables the stop ring to easily spring back into the stop ring groove in the knuckle. Thus, this improves the ease of assembly. Also, the knuckle is formed with a chamfer at the corner of the inner circumferential surface at its inboard side. This enables the stop ring to be easily reduced in diameter. Thus, this further improves the ease of assembly.

According to the invention, the inner rings are immovably secured axially by a caulked portion formed by plastically deforming radially outward the end of the axially extending cylindrical portion. This enables the bearing apparatus to be reduced in weight and size as well as number of parts and accordingly reduces its manufacturing cost.

### EFFECT OF THE INVENTION

The present invention makes it possible to easily destruct only the stop ring and thus achieve disassembly by applying an axial load exceeding the breaking strength of the stop ring determined by its shearing strength on the outer member. Accordingly, it is possible to reuse the knuckle and the outer member without causing damage to them. Thus, the vehicle wheel bearing apparatus is simple to assemble and disassemble. Thus, the invention reduces the man-hour in manufacturing and its manufacturing cost.

### BEST MODE FOR CARRYING OUT THE INVENTION

According to the present invention, a vehicle wheel bearing apparatus comprises an inner member including a hub wheel integrally formed with a wheel mounting flange at one end. Axially extending cylindrical portions axially extend from the wheel mounting flange. Inner rings are fitted on the axially extending cylindrical portions. An outer member is fitted in a knuckle, which forms a part of a suspension apparatus. Double row rolling elements are arranged between the inner and outer members. The wheel hub is rotatably supported by the knuckle. Annular stop ring grooves are formed, respectively, on the outer circumferential surface of the outer member and the inner circumferential surface of the knuckle. A stop ring is fitted in the stop ring grooves and has a shearing strength of 20˜200 MPa.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a longitudinal section view of a first embodiment of a vehicle wheel bearing apparatus of the present invention;

FIG. 2 is a front elevation view of a stop ring of the present invention;

FIG. 3 is a longitudinal section view of a second embodiment of a vehicle wheel bearing apparatus of the present invention; and

FIG. 4 is a longitudinal section view of a vehicle wheel bearing apparatus of the prior art.

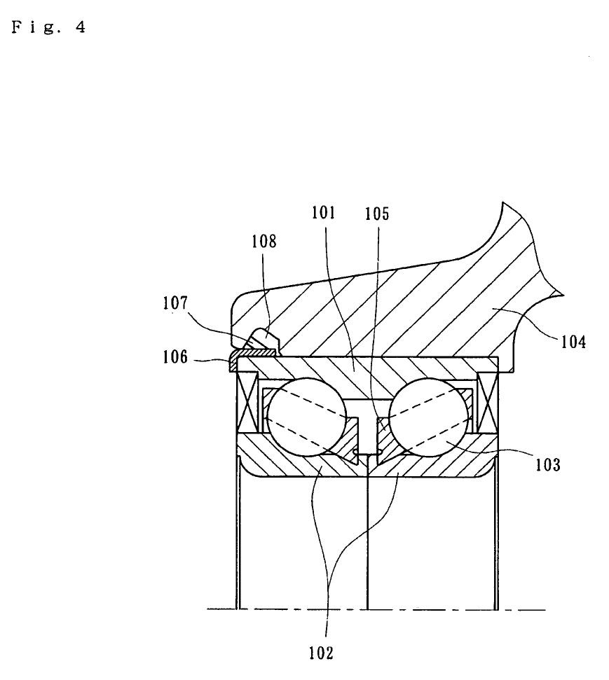

### DETAILED DESCRIPTION OF THE PREFERRED EMBODIMENTS

The following description of the preferred embodiment(s) is merely exemplary in nature and is in no way intended to limit the invention, its application, or uses.

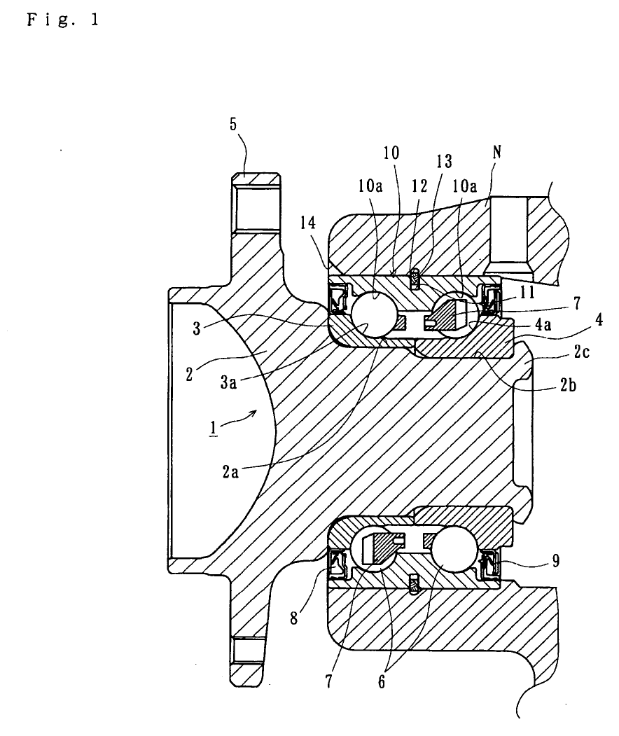

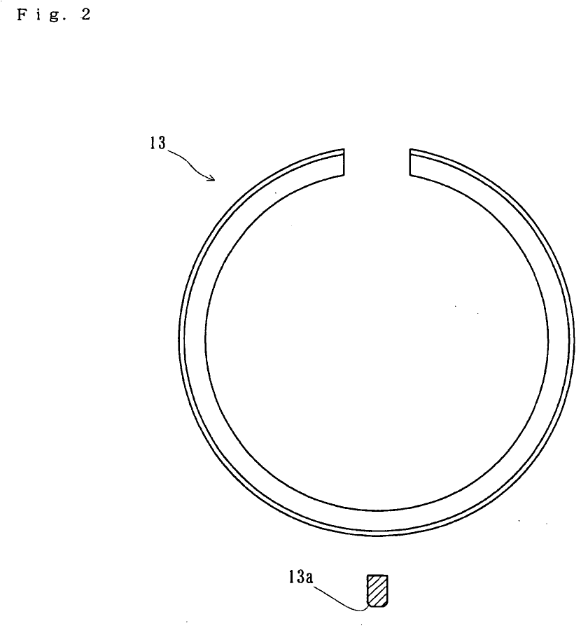

FIG. 1 is a longitudinal section view of a first embodiment of a wheel bearing apparatus of the present invention. FIG. 2 is a front elevation view of a stop ring of the present invention. In the description of the present invention, a side of a bearing positioned outward of the vehicle when it is mounted on a vehicle is referred to as “outboard” side (the left side in a drawing), and a side inward of the vehicle is referred to as “inboard” side (the right side in a drawing).

The wheel bearing apparatus of the present invention includes an inner member 1, an outer member 10, and double row rolling elements 6 ad 6 arranged between the inner and outer members 1 and 10. The inner member 1 includes a hub wheel 2, and inner rings 3 and 4 fitted on the wheel hub 2. The wheel hub 2 is integrally formed with a wheel mounting flange 5 at one end. Cylindrical portions 2a and 2b axially extend from the wheel mounting flange 5. The inner rings 3 and 4 are made of high carbon chrome bearing steel such as SUJ2 and form the inner raceway surfaces 3a and 4a on their outer circumferential surface. The surfaces are hardened to its core by dipping quenching to have the surface hardness of HRC 54˜64.

The inner rings 3 and 4 are press fitted onto the cylindrical portions 2a and 2b which axially extend from the wheel hub. The inner rings 3 and 4 are prevented from being axially slipped off from the cylindrical portions 2a and 2b by a caulked portion 2c. The caulked portion 2c is formed by plastic deformation of the end of the cylindrical portion 2b radially outward. Since this embodiment adopts the self-retaining structure, it is not required to control an amount of pre-pressure caused by fastening force of a nut used in the prior art. In addition, since the thickness of the inner ring 4 at the inboard side is larger than that of the inner ring 3 at the outboard side, it is possible to prevent deformation generation of the inner ring 4 during the caulking work.

The wheel hub 2 is made of medium carbon steel such as S53C including carbon of 0.40˜0.80% by weight. The wheel hub 2 is hardened by high frequency induction quenching so that the base of the wheel mounting flange 5, at its inboard side, and the cylindrical portions 2a and 2b have a surface hardness of 54˜64 HRC. The caulked portion 2c remains a non-quenched portion having its surface hardness less than 24 HRC.

The outer member 10, on its inner circumferential surface, includes double row outer raceway surfaces 10a and 10a which are arranged to oppose the double row inner raceway surfaces 3a and 4a. Double row rolling elements (balls in this embodiment) 6 and 6 are arranged between the inner and outer raceway surfaces 3a, 4a and 10a, 10a and are held by cages 7 and 7. Sealing members 8 and 9 are arranged at the ends of the outer member 10 to prevent both penetration of rain water or dusts from the external circumstances into the bearing apparatus. The outer member 10 is made of high carbon chrome bearing steel such as SUJ2. The outer member 10 is hardened to it core by quenching to have a surface hardness of HRC 54˜64. Although it is illustrated with the double row angular ball bearing using balls 6 and 6, a double row tapered roller bearing using tapered rollers as rolling elements may also be used.

In the embodiment of the present invention, an annular stop ring groove 11 is formed on the outer circumferential surface of the outer member 10. An annular stop ring groove 12, corresponding to the stop ring groove 11, is formed on the inner circumferential surface of the knuckle N which forms a part of the suspension apparatus. A stop ring 13, having open ends, is adapted to be fitted in these grooves 11 and 12.

The stop ring 13 is formed by injection molding of a thermoplastic resin, such as polyamide (PA) 66, which is mingled with reinforcing fibers, such as glass fibers (GF). As shown in FIG. 2, the stop ring 13 has a substantially rectangular cross-section and chamfers 13a at its corners of its outer circumferential surfaces. The material of the stop ring 13 is not limited to those mentioned above and can be selected from any material having the shearing strength of 20˜200 MPa. With setting the shearing strength of the stop ring 13 within a range of 20˜200 MPa, it is possible to prevent the axial movement of the bearing relative to the knuckle during normal use of the vehicle. Also, the stop ring 13 may be destroyed without applying an excessive heavy load during disassembly of the bearing during service of the vehicle. Also, by forming the stop ring 13 of plastic resin, it is possible to appropriately select plastic material with a desirable shearing strength as well as types of reinforcing fibers. In place of plastic materials, it is possible to use any metal material such as light weight alloy of aluminum with a shearing strength lower than that of steel.

Assembling of the bearing apparatus to the knuckle N will be described. First, the stop ring 13 is mounted in the stop ring groove 11 of the outer member 10. Next, the bearing apparatus on, which outer member 10 is provided with the stop ring 13, is inserted into the knuckle N. During insertion, the stop ring 13 first abuts against the chamfered portion 14 formed on the end of the outboard side of the knuckle N and then is pushed into the knuckle N along its inner circumferential surface with the diameter of the stop ring 13 being reduced by compression. When the stop ring 13 arrives at the position of the stop ring groove 12 of the knuckle N, the stop ring springs back into the groove 12. Thus, the stop ring 13 is held in both the groove 11 of the outer member of the bearing apparatus and in the groove 12 of the knuckle N. This prevents the axial movement between the bearing apparatus and the knuckle N.

On the contrary, during disassembly of the bearing apparatus for service of the vehicle, the bearing apparatus can be easily separated from the knuckle N by applying an axial load on the outer member 10. The load exceeds the breaking shearing strength of the stop ring 13 without causing damage both on the knuckle N and the outer member 10.

According to the present invention, any special stop ring and/or special working of the groove is not required. Thus, it is possible to reduce the man-hour in manufacturing and also its manufacturing cost. Also, a vehicle wheel bearing apparatus is provided with low manufacturing cost and simple assembly and disassembly. When the stop ring is made of plastic resin, which has a coefficient of linear expansion larger than that of light weight metal such as aluminum alloy, which is frequently used in forming the knuckle to reduce the weight of vehicle, it is possible to prevent gap generation between the stop ring and the stop ring grooves. Accordingly, this prevents impairment of steering stability and durability of the bearing.

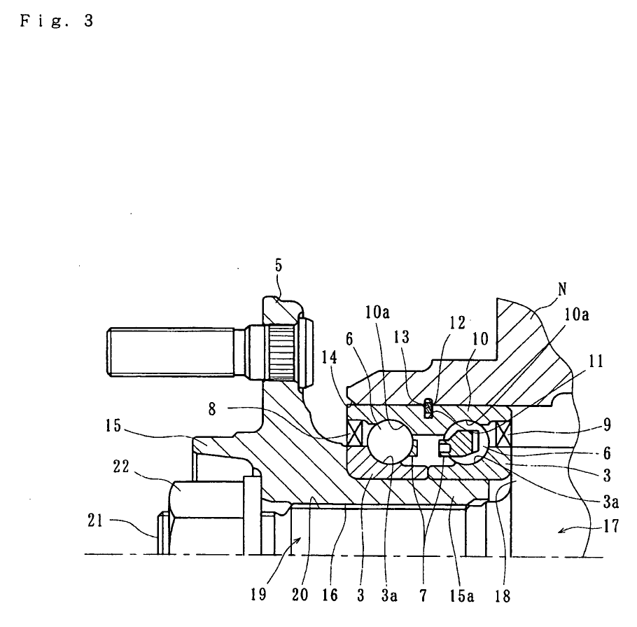

FIG. 3 is a longitudinal-section view of a second embodiment of a vehicle wheel bearing apparatus of the present invention which is applied to a driving wheel of a vehicle. Also in this second embodiment, the same numerals are used as those used in the first embodiment to designate the same structural elements.

A wheel hub 15 is integrally formed with a wheel mounting flange 5 at its outboard end. A cylindrical portion 15a axially extends from the wheel mounting flange 5. A serration (spline) 16 is formed on the inner circumferential surface of the cylindrical portion 15a.

A pair of inner rings 3 and 3 is press-fitted on the wheel hub 15. The inner rings 3 and 3 are secured in a sandwiched condition between a shoulder 18 of an outer joint member 17, forming a constant velocity universal joint (not shown), and the wheel hub 15. The outer joint member 17 is integrally formed with a shaft portion 19 axially extending from the shoulder 18. The outer circumferential surface of the shaft portion 19 is formed with a serration (spline) 20 engaging the serration 16 of the wheel hub 15. The splines 16, 20 transmit torque from an engine (not shown) to the wheel hub 15 via a drive shaft (not shown) and the constant velocity universal joint. A desirable bearing pre-pressure can be obtained by fastening a nut 22 to a thread 21 formed on one end of the shaft portion 19. Thus, the outer member 10 is designed so that it can exhibit an ultra tight interference fit against the knuckle N. On the contrary, the inner rings 3 and 3 are press-fit against the wheel hub 15 through a predetermined interference to exhibit a desirable pre-pressure to prevent bearing creep.

Similarly to the first embodiment, the stop ring 13 springs back into the stop ring groove 12 of the knuckle N when it arrives at the position of the groove 12. Accordingly, the bearing apparatus can be easily separated from the knuckle N by applying an axial load on the outer member 10 which exceeds the breaking shearing strength of the stop ring 13. This occurs without causing damage to both the knuckle N and the outer member 10. Thus it is possible to provide a vehicle wheel bearing apparatus which is simple to assemble and disassemble. Thus, the bearing apparatus can reduce the man-hours in manufacturing and its manufacturing cost.

The present invention has been described with reference to the preferred embodiment. Obviously, modifications and alternations will occur to those of ordinary skill in the art upon reading and understanding the preceding detailed description. It is intended that the present invention be construed as including all such alternations and modifications insofar as they come within the scope of the appended claims or the equivalents thereof.

Applicability in Industry

The vehicle wheel bearing apparatus of the present invention can be applied to any bearing apparatus to support both a driving wheel and a driven wheel without any limitation to the bearing structure so long as the bearing is a type inserted into a knuckle which forms a part of the vehicle suspension.

The description of the invention is merely exemplary in nature and, thus, variations that do not depart from the gist of the invention are intended to be within the scope of the invention. Such variations are not to be regarded as a departure from the spirit and scope of the invention.

1. A bearing apparatus comprising:
an inner member including a hub wheel integrally formed with a wheel mounting flange at one end, axially extending cylindrical portions axially extending from the wheel mounting flange, and inner rings fitted on the axially extending cylindrical portions;
an outer member fitted in a knuckle which forms a part of a suspension apparatus, double row rolling elements arranged between the inner and outer members, the wheel hub being rotatably supported by the knuckle, annular stop ring grooves are formed, respectively, on the outer circumferential surface of the outer member and the inner circumferential surface of the knuckle N; and
a stop ring, having a predetermined shearing strength smaller than that of steel, is fitted in the stop ring grooves.

2. The vehicle wheel bearing apparatus of claim 1, wherein said shearing strength of the stop ring is set within a range of 20˜200 MPa.

3. The vehicle wheel bearing apparatus of claim 1, wherein said stop ring is formed of thermoplastic resin.

4. The vehicle wheel bearing apparatus of claim 1, wherein said stop ring is formed with chamfers at the corners of the outer circumferential surface.

5. The vehicle wheel bearing apparatus of claim 1, wherein aid knuckle is formed with a chamfer at the corner of the inner circumferential surface at its inboard side.

6. The vehicle wheel bearing apparatus of claim 1, wherein said inner rings are immovably secured axially by a caulked portion formed by plastically deforming radially outward the end of the axially extending cylindrical portion.
